(19) United States
(12) Patent Application Publication
(10) Pub. No.: US 2016/0121559 A1
(43) Pub. Date: May 5, 2016

(54) DEPOSITION DEVICE

(71) Applicant: Airbus Defence and Space GmbH, Ottobrunn (DE)

(72) Inventor: Christian WEIMER, Munich (DE)

(73) Assignee: AIRBUS DEFENCE AND SPACE GMBH, Ottobrunn (DE)

(21) Appl. No.: 14/927,588

(22) Filed: Oct. 30, 2015

(30) Foreign Application Priority Data
Oct. 31, 2014 (EP) 14003683.1

(51) Int. Cl. B29C 70/38

(52) U.S. Cl. CPC B29C 70/384

(57) ABSTRACT

A deposition device for depositing fibrous structures in an automated manner on a workpiece includes a plurality of support elements each having at least one deposition head, wherein the at least one deposition head is designed to deposit fibrous structures on the workpiece, and wherein the plurality of support elements and the workpiece are arranged so as to be movable relative to one another in a circumferential direction of the workpiece and in a longitudinal direction of the workpiece.

### FIELD OF THE INVENTION

The invention relates to a deposition device for depositing fibrous structures on a workpiece in an automated manner.

### BACKGROUND OF THE INVENTION

Fibre-reinforced composite fibre materials are being increasingly produced by means of automated deposition of fibrous structures in order to achieve high speeds.

Braiding technology as an automated deposition method allows for high production speeds but is disadvantageous in that more complex fibre structures such as varying thicknesses, which is known as ply drop-off, i.e. ending fibre layers inside the component made of composite fibre material, three-dimensionally curved fibre layers which deviate from a surface line and feeding in individual rovings or fibre strands, cannot be produced thereby.

US 2005/0039843 A1 describes a plurality of deposition units having translational and rotational degrees of freedom. However, these are not capable of forming a braided deposition.

### SUMMARY OF THE DISCLOSURE

One idea of the present invention is to overcome the disadvantages of the prior art, in particular to propose a deposition device for depositing fibrous structures in an automated manner which also produces components having more complex fibrous structures at high speed and in a flexible manner.

A deposition device according to the invention for depositing fibrous structures in an automated manner comprises a plurality of support elements each having at least one deposition head. The at least one deposition head is designed to deposit fibrous structures on the workpiece. In this case, the plurality of support elements and the workpiece are arranged so as to be movable relative to one another in a circumferential direction of the workpiece and in a longitudinal direction of the workpiece.

Within the context of the disclosure, the term “fibrous structure” includes any geometries of fibres which are embedded in a polymer matrix. Polymer-fibre structures of this type include rovings, yarns, UD composites, fibre bands, prepregs or similar semi-finished products that are conventional in composite fibre technology.

The deposition device according to the invention allows for a plurality of producible deposition geometries, including braided depositions, is highly flexible, can produce composite fibrous structures at high speeds and is simple to service. Fibre splicers can be produced and fibre steering is made possible.

In one embodiment, the plurality of support elements is a plurality of ring segments. This geometry allows the support elements and therefore the deposition heads to move in the circumferential direction of the workpiece in a particularly effective and simple manner.

The plurality of support elements can advantageously comprise a plurality of linear guides. In particular, the plurality of support elements can consist of a plurality of linear guides.

According to a further aspect of the invention, the plurality of support elements are mounted so as to be movable relative to one another, at least in part, in the longitudinal direction and/or in the circumferential direction of the workpiece. This allows for particularly high flexibility during production and makes it possible to produce more complex fibre deposition structures, which also replicates a braided deposition.

According to another embodiment, at least some of the plurality of support elements are arranged in a ring around the component. As a result, in particular when the support elements are formed as ring segments, but also when they are not, they can be moved in the circumferential direction of the workpiece in a particularly simple manner.

At least some of the deposition heads can advantageously be mounted on at least some of the support elements so as to be radially pivotable relative to the workpiece by an angle. As a result, the angle at which the fibrous structure is deposited on the workpiece can be varied. This can be advantageous in particular if the surface of the workpiece is uneven.

According to another aspect of the invention, at least one deposition head can be designed to be able to deposit a plurality of fibrous structures on the workpiece at the same time. This further increases the flexibility and production speed of the deposition device.

According to another variant, at least some of the support elements can form an array. This can advantageously make it possible for the deposition device to deposit particularly complex structures. In particular, fibrous structures, in particular fibre strands or fibre bands, can be deposited on the workpiece in a braided structure in the manner of a braided system.

A plurality of deposition heads can advantageously be actuated independently of one another. As a result, individual fibrous structures such as rovings can be individually placed and deposited on the component (ply drop-off).

In an embodiment, at least some of the deposition heads may have a cutting device. This makes it possible to produce varying thicknesses.

In a particular embodiment, all the deposition heads may have a cutting device. This further increases the flexibility of the possible fibre deposition structures.

Moreover, it can be advantageous for at least some of the deposition heads and/or at least some of the support elements to have a material feed for feeding fibrous material, in particular continuous fibrous material.

According to one variant, the material feed can be an external material feed and/or can originate from a creel.

Furthermore, in addition to the movable mounting of the support elements and/or alternatively thereto, the workpiece can be mounted so as to be movable in the longitudinal direction and/or circumferential direction. This also contributes to the flexibility of the production method using the deposition device. In particular, the support elements therefore do not have to move around the workpiece in the circumferential direction, and therefore the material can be fed from a creel, in particular from a standard creel.

According to another aspect of the invention, at least some of the support elements can be mounted such that they can be removed individually. This can, for example, make it easier to service and clean the support elements and therefore the deposition heads.

According to another aspect, at least some of the support elements can be moved into a non-operating position. This can be advantageous in that the respective support elements do not obstruct the rest of the support elements, which can therefore also be moved during normal operation when one supporting element or deposition head is being serviced. The fact that support elements are easier to remove and therefore service, i.e. also clean, in a non-operating position can also be expedient.

Other advantageous embodiments of the present invention form the subject matter of additional dependent claims.

### BRIEF DESCRIPTION OF THE DRAWINGS

Additional embodiments and advantages of the invention are explained in more detail hereinafter on the basis of a preferred embodiment and with reference to schematic drawings, in which:

FIG. 1 is a schematic oblique view of a cylindrical workpiece together with a deposition device according to the invention, and

FIG. 2 is a schematic side view of a workpiece having an irregular shape together with a deposition device according to the invention.

In the figures, identical structural elements bear the same reference numerals.

### DETAILED DESCRIPTION OF EMBODIMENTS OF THE INVENTION

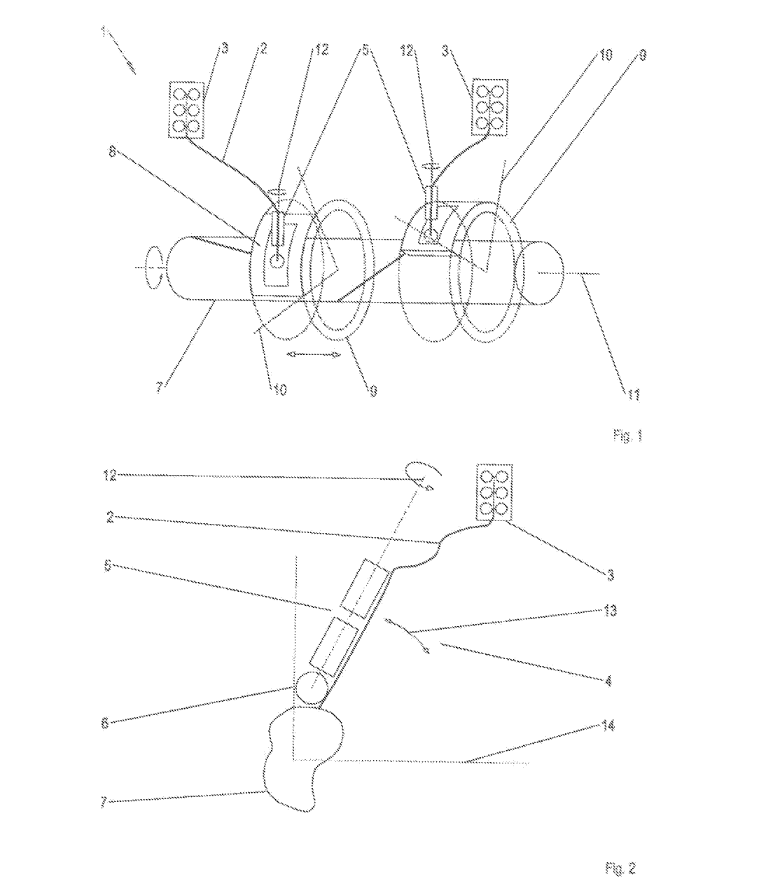

FIG. 1 shows a deposition device 1 for depositing fibrous structures 2 which are in particular made of carbon fibres and are provided with a polymer matrix. Said matrix can contain either a thermoplastic or a thermosetting plastics material. The material feed 3 of the fibrous structures 2, which are shown schematically in FIG. 1 as a fibre band consisting of a plurality of rovings, is carried out from a creel in FIG. 1 and FIG. 2. Alternatively, the material feed 3, in particular of continuous fibrous material, can also be carried out as an external material feed.

By means of a guide system 4, the fibrous structures are guided towards the deposition heads 5, which deposit the fibrous structures 2 on the workpiece 7 by means of deposition rollers 6. The deposition heads 5 are arranged on support elements 8 which are mounted on an annular web 9 (indicated by dotted lines) so as to be movable around the workpiece 7 in the circumferential direction. In this embodiment, the support elements 8 are formed as ring segments. These can move on the annular web 9 in a particularly simple manner. The angle 10 which the ring segments 8 assume is indicated by finely dashed lines. If the angle 10 measures 60° for example, six ring segments 8 can be arranged so as to form a complete ring. This closed ring could be fixed at least reversibly so that, at least at certain times, the ring segments are arranged so as to only be movable together in the circumferential direction. By releasing the six ring segments 8, said segments can be arranged so as to be movable in the longitudinal direction of the workpiece 7 once again. It is also conceivable for a plurality of closed rings made up of ring segments 8 to be arranged around the workpiece 7.

The support elements 8 shown in FIG. 1 are arranged so as to be movable relative to one another and relative to the workpiece 7 in both the circumferential direction and the longitudinal direction of the workpiece 7. In addition or alternatively, the workpiece 7 can be mounted so as to be rotatable about an axis of rotation 11 and so as to be movable in the longitudinal direction.

The deposition heads 5 themselves can also be mounted on the support elements 8 so as to be movable along a rotational axis 12. This allows for an additional degree of freedom when the fibrous structure 2 is being deposited. The deposition heads 5 are mounted so as to be pivotable relative to the support elements 8 within an angle 13. This angle 13 is shown by way of example in FIG. 2 as a 90° angle 14. Pivotability of this kind improves the deposition behaviour in particular on a workpiece 7 having an irregular shape, as is shown schematically in FIG. 2. In addition, in this embodiment all the support elements are provided with linear guides which allow for substantially frictionless translation of the deposition heads 5 on the support elements.

A cutting device (not shown) on the deposition heads 5 allows for varying thicknesses.

The support elements can be moved into a non-operating position in which they can be directly serviced and/or removed and then serviced. In this case, the production process can be advantageously continued. Short downtimes are therefore achievable.

In one variant of the embodiment (not shown), four ring segments 8 form an array, for example, which can be actuated such that a braided deposition can be replicated and a cross pattern can be produced from rovings.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding EP Application No. 14003683.1, filed Oct. 31, 2014 are incorporated by reference herein.

What is claimed is:

1. A deposition device for depositing fibrous structures in an automated manner on a workpiece, comprising:
a plurality of support elements each having at least one deposition head, the at least one deposition head being designed to deposit fibrous structures on the workpiece, and the plurality of support elements and the workpiece being arranged so as to be movable relative to one another in a circumferential direction of the workpiece and in a longitudinal direction of the workpiece.

2. The deposition device according to claim 1, wherein the plurality of support elements comprise a plurality of ring segments.

3. The deposition device according to claim 1, wherein the plurality of support elements comprises a plurality of linear guides.

4. The deposition device according to claim 1, wherein the plurality of support elements are mounted so as to be movable relative to one another, at least in part, in the longitudinal direction and/or in the circumferential direction of the workpiece.

5. The deposition device according to claim 1, wherein at least some of the plurality of support elements are arranged in a ring around the workpiece.

6. The deposition device according to claim 1, wherein at least some of the deposition heads are mounted on at least some of the support elements so as to be radially pivotable relative to the workpiece by an angle.

7. The deposition device according to claim 1, wherein at least one deposition head is designed to be able to deposit a plurality of fibrous structures on the workpiece at the same time.

8. The deposition device according to claim 1, wherein at least some of the support elements form an array.

9. The deposition device according to claim 1, wherein a plurality of deposition heads are actuatable independently of one another.

10. The deposition device according to claim 1, wherein at least some of the deposition heads have a cutting device.

11. The deposition device according to claim 1, wherein at least some of the deposition heads and/or at least some of the support elements have a material feed for feeding fibrous material.

12. The deposition device according to claim 11, wherein the material feed is an external material feed and/or originates from a creel.

13. The deposition device according to claim 1, wherein the workpiece is mounted so as to be movable in the longitudinal direction and/or circumferential direction.

14. The deposition device according to claim 1, wherein at least some of the support elements are mounted such that they can be removed individually.

15. The deposition device according to claim 1, wherein at least some of the support elements are movable into a non-operating position.
